(19) United States
(12) Patent Application Publication
(10) Pub. No.: US 2010/0306307 A1
(43) Pub. Date: Dec. 2, 2010

(54) SYSTEM AND METHOD FOR SOCIAL BOOKMARKING/TAGGING AT A SUB-DOCUMENT AND CONCEPT LEVEL

(75) Inventors: Michael Baessler, Boeblingen (DE); Andrea Elias, Boeblingen (DE); Thilo Goetz, Boeblingen (DE); Thomas Hampp-Bahnmueller, Boeblingen (DE); Sebastian Nelke, Boeblingen (DE)

Correspondence Address: Cantor Colburn LLP - IBM SVL, 20 Church Street, 22nd Floor, Hartford, CT, 06103-3207, US

(73) Assignee: INTERNATIONAL BUSINESS MACHINES CORPORATION, Armonk, NY (US)

(21) Appl. No.: 12/475,550

(22) Filed: May 31, 2009

(51) Int. Cl. G06F 17/00; G06F 15/16; G06F 17/30

(52) U.S. Cl. 709/203; 715/234

(57) ABSTRACT

According to one embodiment of the present invention, a method for social bookmarking and tagging documents is provided. According to one embodiment of the present invention, a method comprises receiving a new document in a tagging server having a storage unit with stored tags associated with a preexisting document and comparing the new document with the tags using a processor to find matching instances between parts of the new document and the tags. Each matching instance in the new document is marked with tag information. The marked up new document is delivered for display on a display unit.

### BACKGROUND

The present invention relates to Web 2.0 technologies, and more specifically, to social bookmarking and tagging of documents.

Web 2.0 is a term generally used to refer to the concept of a second generation of web-based communities and hosted services which aim to facilitate creativity, collaboration and sharing among users. Examples of Web 2.0 include social networking sites, blogs, wikis, social bookmarking and collaborative tagging. Consumer focused Web 2.0 sites, such as Flickr.com, Gmail.com, and Facebook.com, have brought about a new level of dynamic categorization, classification, and personalization. In these websites, instead of having objects, such as email, music or images, placed into predefined categories, consumers choose words or short phrases (tags) to organize and categorize the data objects. Also, multiple tags can be applied to a data object, which then become public categories which other users can tag. As a community of users grows around a site (social networking), the amount of data available for browsing, as well as the variety of tags (and thus dimensions of classification) for the piece of data increase, making it easier for a user to find data objects of interest.

Social bookmarking sites like del.icio.us, Flickr, or Facebook allow their users to tag various “artifacts” (web pages, documents, photos, people from membership lists etc.) and share the tags to help with search, navigation, discovery, and retrieval. The artifacts tagged (web pages, photos, documents etc.) are typically unstructured documents.

### SUMMARY

According to one embodiment of the present invention, a method comprises: receiving a new document in a tagging server having a storage unit with stored tags associated with a preexisting document; comparing the new document with the tags using a processor to find matching instances between parts of the new document and the tags; marking up each matching instance in the new document with tag information; and delivering the marked up new document for display on a display unit.

According to another embodiment of the present invention, a method comprises: receiving an electronic document in a tagging and analysis server; comparing the electronic document with previously stored tags using a part tagging processor, the comparing identifying instances of matches between the electronic document and the previously stored tags, the previously stored tags being stored in a tag definition unit; marking up each matching instance in the electronic document with the stored tag information using a part tagging unit; and delivering the marked up electronic document for display on a display unit.

According to a further embodiment of the present invention, a system comprises: a server including a processor; an entity tagging unit coupled to the processor including a memory containing stored tag definitions; and a part tagging unit coupled to the processor including a document identifier and a part location identifier, the part location identifier including information relating to the location of tagged items within a document, wherein the server receives a document and marks up the document with tag information using the entity tagging unit and the part tagging unit.

According to another embodiment of the present invention, a computer program product for tagging documents at a sub-document level comprises: a computer usable medium having computer usable program code embodied therewith, the computer usable program code comprising: computer usable program code configured to: provide information defining tags for parts of a document; receive a new document to be displayed; compare the new document with the tags to find matching instances between parts of the new document and the tags; mark up each match instance in the new document with tag information; and deliver the marked up new document for displaying the marked up new document with the tag information.

### BRIEF DESCRIPTION OF THE SEVERAL VIEWS OF THE DRAWINGS

FIG. 1 shows a diagram of a system for tagging documents in accordance with an embodiment of the invention;

FIG. 2 shows a diagram of a tagging and analysis server in accordance with an embodiment of the invention;

FIG. 3 shows a flowchart of a process for tagging at a sub-document level in accordance with an embodiment of the invention;

FIG. 4 shows a flowchart of a process for tagging at a sub-document level in accordance with an embodiment of the invention; and

FIG. 5 shows a high level block diagram of an information processing system useful for implementing one embodiment of the present invention.

### DETAILED DESCRIPTION

Embodiments of the invention provide a system, method and computer program product for sharing tagging information in two ways. First, specific parts of an artifact may be tagged as instances within a larger artifact. For example, a user may tag one or more sections within a longer article with mixed content about databases in general, e.g., as “DB2 performance tips”, and then share them as tagged parts, instead of sharing tags for the whole document. Second, a user may tag specific entities mentioned in an artifact (e.g., tag an occurrence of the product name “DB2” with the tag comment “IBM enterprise database. Link: “http://www-306.ibm.com/software/data/db2/”) and share it in a way that assigns the tag not only the specific mention of “DB2” in the document in which the tag was created, but in any document that mentions “DB2”.

Neither of these two ways of sharing the tag information is currently supported by existing collaborative tagging systems. In particular, the currently available systems are limited to annotating complete artifacts, e.g., assigning a tag like “DB2 Tips” to an entire web page that has many hints about the DB2 software. Current systems don't support marking up a part of an artifact, assigning a tag just to the marked part, or sharing that tag information.

If that part is a self contained, small entity like a person's name, product reference, location name or a title of a book or song, it is very likely that many other documents will contain mentions of the same part/entity. It would be helpful if a tagging of such parts could be done in a way that automatically tags that part in any document, not just in the one that provides the context for the initial tag definition. This kind of tagging can be something like a comment about a person, product, place, or artifact that people want to share. For example, a user might want to tag the name of the band “The Good, the Bad and the Queen” with the comment “British alternative band” and publish it to be associated with any occurrence of that name in any document.

It may be noted that in the present description the word “tag” is not limited to one or more words. A “tag” can be more complex metadata. For example, a tag may contain links. That is, a tag may contain a link to a band's official web presence, a link to a Wikipedia article with the band's bio, a fan forum, a You Tube clip, a page containing the latest concert dates, etc. Also, a tag may contain digital data such as photos or a video or audio clip taken during a live concert, etc.

It may also be noted that there are other kinds of systems that are designed to let humans mark up documents and store the documents with their additional mark-up for later use by others. Examples include corpus tagging or annotation environments used by linguists. See for example the Jena Annotation Environment (JANE) https://watchtower.coling.uni-jena.de/˜tomanek/coling/JANE/. A related patent is US20060020882A1, “Method and Apparatus for Capturing and Rendering Text Annotations for Non-Modifiable Electronic Content”. Unlike corpus tagging systems, social bookmarking systems (including the present invention) focus on collaborative tagging of public web content where the documents that are being tagged are public and not owned by the tagging person or system. Since the documents in social bookmarking systems are public, the mark-up, or tag information, cannot be stored within the actual document. Unlike corpus tagging systems, social bookmarking systems are designed to allow for public sharing of tags and tag information. Finally, even though corpus tagging systems typically support mark-up of arbitrary parts, they don't support entity mark-up where the mark-up is defined for and appears in any document that matches a generic entity definition.

For a tagging system in accordance with embodiments of the invention, three different aspects may be implemented:

1.) Define a new tag (publish for sharing): This means specifying what document (part/entity) the tag is about and then provide all the tag metadata.

2.) Browsing/searching (by tag information): This permits users to see a list of all tags that are defined. This list may include both self-defined tags, as well as tags shared by the community. For each browsed tag, this functionality may permit the user to see all associated metadata including links, comments, images, video clips, etc. For any given tag, a user may view all documents (or parts/entities) that are associated with that tag.

3) Display (by document): For a given document, in accordance with embodiments of the invention, users may see which tags are associated with it. For parts/entities, this typically involves highlighting the location of the part/entity within the document.

Existing tagging systems are typically implemented as databases/catalogues that associate each defined tags with the list of documents users have associated with that tag. This catalogue can be queried using services. Documents are typically represented as URIs or URLs. Simple tags are typically represented as strings. More complex tags are rarely used in current systems, but they may include links and digital data like images or video clips. Existing systems cannot support part/entity tagging.

Embodiments of the invention allow a number of functionalities not found in existing systems. These include: (1) allowing the creation of tags that refer to parts or entities; (2) allowing users to browse these parts; and (3) allowing the display of the tags for a given document.

To support tagging of parts/entities the present invention performs an active analysis of document content to identify the parts/entities they may contain. When a user wants to see the tags for a given document, the system analyzes the content of the document and dynamically computes which parts/entities occur in this particular document. This is a more complicated task compared to the simple look-up of a document URI in a tag catalogue. The analysis may be aware of which tags are defined and have ways to identify them in a document. It may deal with document formats. For example, it may find tags within a PDF document, which is more complicated than finding them in plain text. Also, the present invention may address part/entity variants. For example the system may find that a document contains a mention of the band name “The Good, the Bad and the Queen”, even if it is spelled in different ways. To achieve this, embodiments of the invention may combine document format conversion technology with entity detection technology.

To support browsing of documents that contain a given part/entity, the present invention provides a search system that can find documents that contain the tags from the tag catalogue. To accomplish the above-described tagging functionality, embodiments of the invention analyses the artifact, identifies previously tagged parts and displays the tags as custom annotation in a system. Existing technologies in the areas of unstructured analysis, entity detection, automatic annotation and smart tagging, may be adapted to store and (re-) find sub-artifact parts and index them for search and discovery.

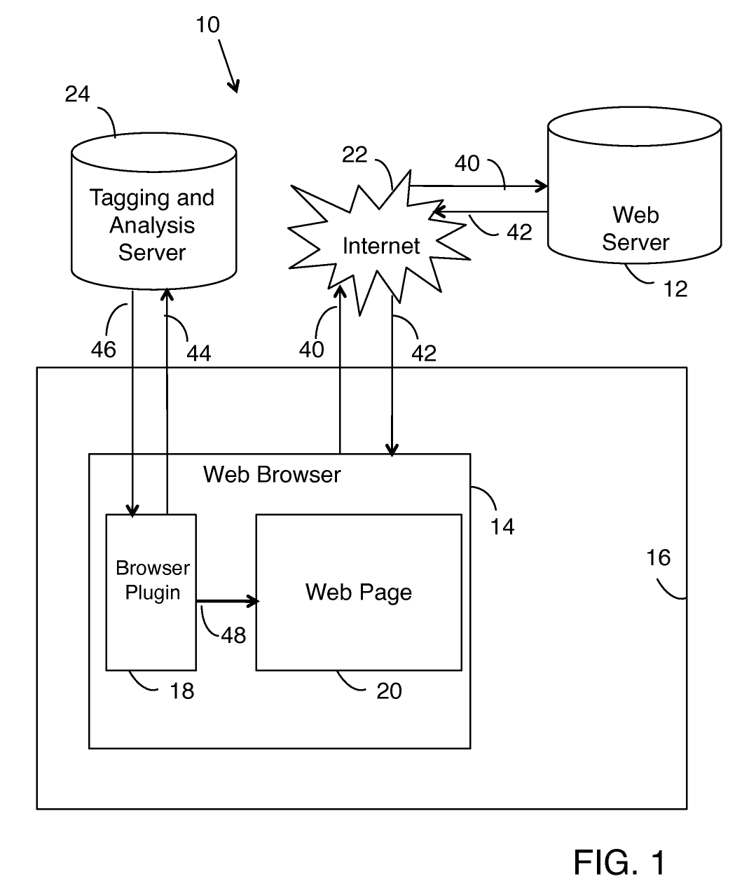

Referring now to FIG. 1, a tagging system in accordance with an embodiment of the present invention is shown. The system 10 includes a web server 12 and a web browser 14, which may reside in a client computer 16. The web browser 14 may include a browser plug-in 18 and the web browser is typically using a display 20 of the client computer 16 for displaying a web page. The web server 12 and the client computer 16 may be connected to each other through the internet 22.

The client computer may be connected to a tagging and analysis server 24, which may be connected through various means to the client computer 16, or may reside in the client computer 16. The tagging and analysis server 24 keeps track of each tag that users input in a data store. It is noted that some existing collaborative tagging systems may also have a kind of tagging and analysis system with a data store. However, to accomplish entity/part tagging, the data store must store more than just associations of document identifiers with tag information, which is accomplished by present inventions.

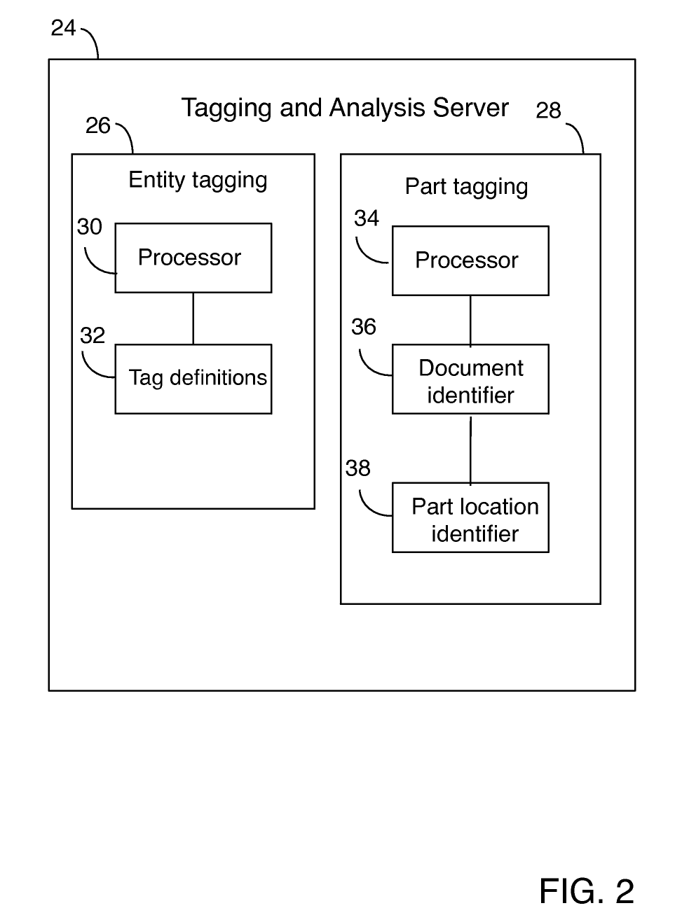

FIG. 2 shows additional details of the tagging and analysis server 24 in accordance with an embodiment of the invention. The tagging and analysis server 24 includes an entity tagging component 26 and a part tagging component 28. The entity tagging component 26 includes a processor and a tag definition storage component 32. Tag definitions, as used herein, are instructions on how to find instances of the tag within a document. A simple example would be if the entity “DB2” has been tagged, the tag definition may be as simple as the word “DB2”. In this case, all the documents containing the word “DB2” would be considered to be an instance of that tag. In a more complex example, the tag definition may contain the word “DB2”, plus some synonyms of the word or information to disambiguate an occurrence. An even more sophisticated tag definition may use regular expressions or linguistic rules. For example, one such rule may be to only mark a tag occurrence if a certain part of speech and a given linguistic context is present.

The part tagging component 28 includes a processor 34, a document identifier unit 36, and a part location unit 38. The document identifier unit 36 may store a document identifier, augmented with information about part location. The part location information may be stored in the part location unit 38. There are several implementation options for part location. Examples of implementation options include storing offsets, DOM tree paths, or by citing the information that allows searching for the beginning and end of the section.

The common logic underlying both entity tagging 26 and part tagging 28 components is that, unlike prior systems, embodiments of the invention do not store a static document id as the referent of the tag, but store information on how to dynamically find the referent of a tag in given document content (and metadata).

The tagging and analysis system 24 with the above-discussed entity and part tag information can be used to browse a list of defined tags by listing the tag contents, just like in a conventional system. But instead of showing a static list of all documents associated with a tag, the tagging and analysis system 24 may show the instructions on how to find the tag referent in the case of entity tags (e.g. the list of keywords like “DB2” and its synonyms). For part tags it may show the document id plus the occurrence location information. An important difference between the tagging and analysis system 24 and a conventional system is the manner in which tagging information is displayed.

Referring again to FIG. 1, the manner in which a web page or electronic document is dynamically associated with tag information based on the document content may be summarized in the following 5 steps in accordance with an embodiment of the invention.

At the arrows labelled 40, the user types a URI or URL into the browser bar. The browser 14 initiates a request of the corresponding web page over the internet 22. At the arrow 42, the web server 12 delivers the page back to the browser; the browser displays the content on the display 20. At the arrow 44, the browser plug-in 18 grabs the content of the electronic document, and passes it to the tagging and analysis server 24. The tagging and analysis server 24 processes the document content, compares the document with the tags and finds instruction from the store of existing tags. This can involve searching the document for instances of the words in the tag definition (e.g. “DB2” and its synonyms). Each matching instance is marked up with tag information (tag label and complex metadata-like comments, a category, or binary data, such as images). Finally, at arrow 46 this dynamically marked up document is send back to the web browser 14 in a suitable format (e.g. HTML or XML). At arrow 48, the browser plug-in 18 parses the information received from the tagging and analysis server 24 and applies it to the document displayed in the browser. This could be done by modifying the document's DOM tree if the document is written in HTML.

The tagged parts and entities contained in the document may then be visually marked and enriched with corresponding tag meta data (the tag name, the comments users made, the category the tag belongs to, images, etc.). There are several implementation options to show the enriched information for each marked tag within a document. Implementation options include tool-tips, pop up windows or interleaved information within the document.

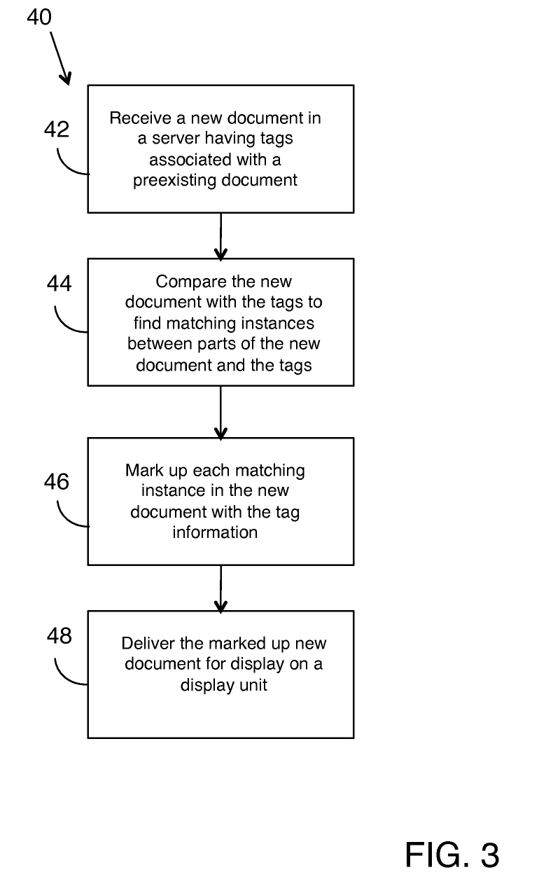

FIG. 3 shows a flowchart of a process 40 for tagging at a sub-document level in accordance with an embodiment of the invention. A new document is received in a server having tags associated with a pre-existing document, in block 42. This server may be the tagging and analysis server shown in FIG. 2. In block 44, the new document is compared with the tags in the pre-existing document to find matching instances between parts of the new document and the tags. Each marching instance is marked up in the new document with tag information, in block 46. The marked up new document is then displayed on a display unit, in block 48.

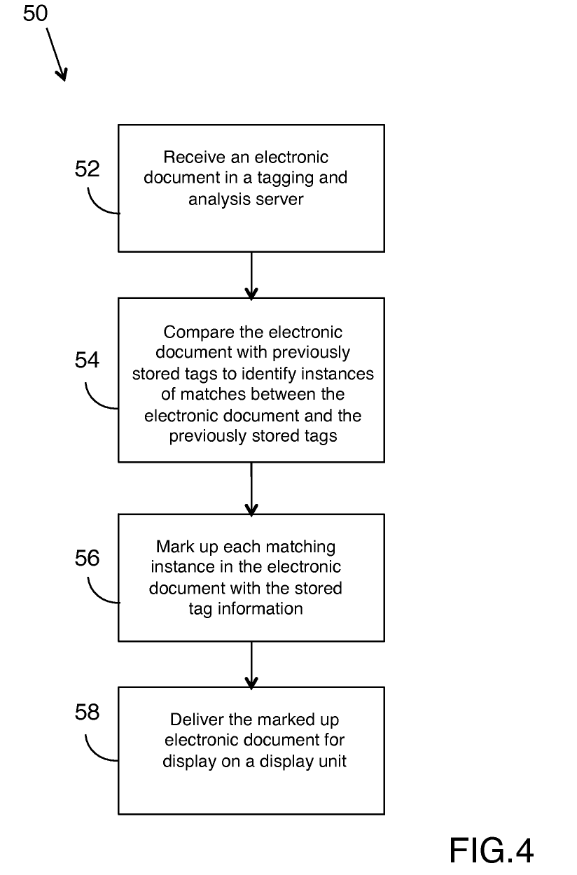

FIG. 4 shows a flowchart of a process 50 for tagging at a sub-document level in accordance with another embodiment of the invention. In block 52, an electronic document is received in a tagging and analysis server. The electronic document is compared with previously stored tags to identify instances of matches between the electronic document and the previously stored tags, in block 54. In block 56, each matching instance in the electronic document is marked up with the stored tag information. The marked up electronic document is delivered for display on a display unit, in block 58.

As can be seen from the above disclosure, embodiments of the invention provide techniques for social bookmarking and tagging at a sub-document and concept level. As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer, or other programmable data processing apparatus, to cause a series of operational steps to be performed on the computer, or other programmable apparatus, to produce a computer implemented process such that the instructions, which execute on the computer or other programmable apparatus, provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

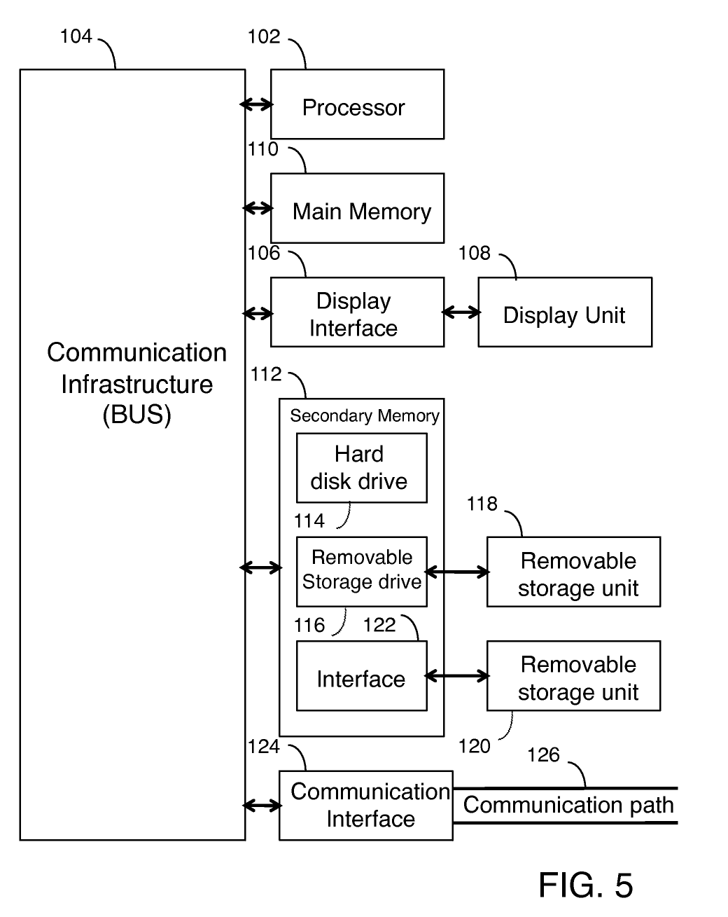

FIG. 5 is a high level block diagram showing an information processing system useful for implementing one embodiment of the present invention. The computer system includes one or more processors, such as processor 102. The processor 102 is connected to a communication infrastructure 104 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 106 that forwards graphics, text, and other data from the communication infrastructure 104 (or from a frame buffer not shown) for display on a display unit 108. The computer system also includes a main memory 110, preferably random access memory (RAM), and may also include a secondary memory 112. The secondary memory 112 may include, for example, a hard disk drive 114 and/or a removable storage drive 116, representing, for example, a floppy disk drive, a magnetic tape drive, or an optical disk drive. The removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc. which is read by and written to by removable storage drive 116. As will be appreciated, the removable storage unit 118 includes a computer readable medium having stored therein computer software and/or data.

In alternative embodiments, the secondary memory 112 may include other similar means for allowing computer programs or other instructions to be loaded into the computer system. Such means may include, for example, a removable storage unit 120 and an interface 122. Examples of such means may include a program cartridge and cartridge interface (such as that found in video game devices), a removable memory chip (such as an EPROM, or PROM) and associated socket, and other removable storage units 120 and interfaces 122, which allow software and data to be transferred from the removable storage unit 120 to the computer system.

The computer system may also include a communications interface 124. Communications interface 124 allows software and data to be transferred between the computer system and external devices. Examples of communications interface 124 may include a modem, a network interface (such as an Ethernet card), a communications port, or a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (i.e., channel) 126. This communications path 126 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 110 and secondary memory 112, removable storage drive 116, and a hard disk installed in hard disk drive 114.

Computer programs (also called computer control logic) are stored in main memory 110 and/or secondary memory 112. Computer programs may also be received via communications interface 124. Such computer programs, when executed, enable the computer system to perform the features of the present invention as discussed herein. In particular, the computer programs, when executed, enable the processor 102 to perform the features of the computer system. Accordingly, such computer programs represent controllers of the computer system.

From the above description, it can be seen that the present invention provides a system, computer program product, and method for implementing the embodiments of the invention. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving a new document in a tagging server having a storage unit with stored tags associated with a preexisting document;
comparing the new document with the tags using a processor to find matching instances between parts of the new document and the tags;
marking up each matching instance in the new document with tag information; and
delivering the marked up new document for display on a display unit.

2. The method according to claim 1 wherein comparing the new document with the tags comprises searching the new document for instances of words in a tag definition.

3. The method according to claim 1 wherein marking up each matching instance comprises marking up each matching instance in the new document with a tag label and complex metadata.

4. The method according to claim 1 wherein marking up each matching instance comprises marking each matching instance in the new document with metadata.

5. The method according to claim 4 wherein the metadata includes at least one of the following: user comments, tag category, links and arbitrary binary data.

6. The method according to claim 1 wherein the new document is an HTML document, the method further comprising:
parsing the marked up electronic document and applying tagging information to the electronic document using a browser; and
displaying the marked up electronic document on the display unit using the browser.

7. The method according to claim 6 wherein applying tagging information comprises modifying a document object model (DOM) tree of the new document.

8. The method according to claim 1 further comprising:
storing a document ID for the new document; and
storing part location information for a particular part of the new document.

9. The method according to claim 1 further comprising marking the new document with a document ID and offset information.

10. A method comprising:
receiving an electronic document in a tagging and analysis server;
comparing the electronic document with previously stored tags using a part tagging processor, the comparing identifying instances of matches between the electronic document and the previously stored tags, the previously stored tags being stored in a tag definition unit;
marking up each matching instance in the electronic document with the stored tag information using a part tagging unit; and
delivering the marked up electronic document for display on a display unit.

11. The method according to claim 10 wherein the stored tag information includes information identifying particular parts of documents.

12. The method according to claim 10 further comprising marking the electronic document with a document ID and offset information.

13. The method according to claim 10 wherein marking up each matching instance comprises marking up each matching instance in the electronic document with at least one of the following: a tag label, a category, links and binary data.

14. The method according to claim 10 wherein the electronic document is an HTML document, the method further comprising:
parsing the marked up electronic document and applying tagging information to the electronic document using a browser; and
displaying the marked up electronic document using the browser.

15. The method according to claim 14 wherein the electronic document is an HTML document, and applying tagging information comprises modifying a document object model (DOM) tree of the electronic document.

16. A system comprising:
a server including a processor;
an entity tagging unit coupled to the processor including a memory containing stored tag definitions; and
a part tagging unit coupled to the processor including a document identifier and a part location identifier, the part location identifier including information relating to the location of tagged items within a document, wherein the server receives a document and marks up the document with tag information using the entity tagging unit and the part tagging unit.

17. The system according to claim 16 wherein the entity tagging unit includes a set of linguistic rules relating to when to tag an occurrence of a particular tag.

18. The system according to claim 16 further comprising:
a client computer including a browser and a browser plug-in, wherein the browser plug-in receives the marked up document from the server and applies the tag information to the document in the browser; and
display unit for displaying the marked up document received from the browser.

19. The system according to claim 18 wherein the document is an HTML document and the browser plug-in modifies the document's document object model (DOM) tree.

20. The system according to claim 14 wherein the server marks up the document with a document ID and offset information.

21. A computer program product for tagging documents at a subdocument level, the computer program product comprising:
a computer usable medium having computer usable program code embodied therewith, the computer usable program code comprising:
computer usable program code configured to:
provide information defining tags for parts of a document;
receive a new document to be displayed;
compare the new document with the tags to find matching instances between parts of the new document and the tags;
mark up each match instance in the new document with tag information; and
deliver the marked up new document for displaying the marked up new document with the tag information.

22. The computer program product according to claim 22 wherein the comparing comprises searching the document for instances of the words in a tag definition.

23. The computer program product according to claim 22 wherein the marking up comprises marking up the match instance with tag information selected from at least one of the following: a tag label, a category, and binary data.

24. The computer program product according to claim 22 wherein the marking comprises marking with metadata.

25. The computer program product according to claim 24 wherein the metadata includes metadata selected from at least one of the following: tag name, user comments, tag category and an image.
